(19) United States
(12) Patent Application Publication
(10) Pub. No.: US 2016/0275601 A1
(43) Pub. Date: Sep. 22, 2016

(54) Modified Japanese Reverse Auction

(71) Applicant: Global eProcure, Clark, NJ (US)

(72) Inventor: Pranav Padgaonkar, Thane (IN)

(73) Assignee: Global eProcure, Clark, NJ (US)

(21) Appl. No.: 14/661,578

(22) Filed: Mar. 18, 2015

(51) Int. Cl. G06Q 30/08

(52) U.S. Cl. CPC G06Q 30/08

(57) ABSTRACT

Disclosed is a modified Japanese reverse auction and a system which implements the method. In accordance with example embodiments, a system may include a server having a computer readable medium encoded with instructions to cause a processor to determine whether at least one bidder in the auction failed to opt into the auction at an earlier stage and, if so, offer the at least one bidder an opportunity to reenter the auction provided the total number of times the at least one bidder failed to enter the auction does not exceed a preset value.

### BACKGROUND

1. Field

Example embodiments related to a method of conducting an auction and a system for implementing the auction.

2. Description of the Prior Art

Reverse Japanese auctions offer a bidding format for those looking to maximize a number of potential award candidates at a particular price. FIG. 1 is a flowchart illustrating steps associated with a classical Japanese auction 10. As shown in FIG. 1, the classical Japanese auction 10 begins by announcing an opening price 20 for an item. The item may be anything, for example, electronic equipment, clothing, computer hardware and/or computer software. In the classical Japanese auction 10 suppliers of the items are allowed two minutes to opt-in to the auction 30. In the event two or more suppliers opt in, the bid price is decreased by a step 40 and the suppliers are again allowed to opt-in at the new price. In the event only a single supplier opts in (or no supplier opts in), then the auction terminates and the business is distributed to the single supplier or the suppliers at the previous stage 50.

### SUMMARY

Applicant has noted that the classical Japanese reverse auction suffers several drawbacks. First, the classical Japanese reverse auction may not result in buyers having optimal pricing. This is because a supplier may be automatically awarded business in the event competitors do not bid on the item. Second, the classical Japanese reverse auction requires explicit opt-in from suppliers at every bid decrement. In the event a supplier misses a bid there is no way for the supplier to opt back into the auction. In view of the above, Applicant has devised a modified Japanese reverse auction which tends to influence suppliers to provide better pricing for a buyer while providing suppliers an option to rejoin the auction in the event they inadvertently failed to join the auction at an earlier stage.

In accordance with example embodiments a method of conducting an auction may include determining whether at least one bidder in the auction failed to opt into the auction at an earlier stage and, if so, offer the at least one bidder an opportunity to reenter the auction provided the total number of times the at least one bidder failed to enter the auction does not exceed a preset value.

In accordance with example embodiments, a control method by a server connected to a plurality of supplier terminals through a network may include using a CPU to determine whether at least one bidder in the auction failed to opt into the auction at an earlier stage and, if so, offer the at least one bidder an opportunity to reenter the auction provided the total number of times the at least one bidder failed to enter the auction does not exceed a preset value.

In accordance with example embodiments, a system may include a server having a computer readable medium encoded with instructions to cause a processor to determine whether at least one bidder in the auction failed to opt into the auction at an earlier stage and, if so, offer the at least one bidder an opportunity to reenter the auction provided the total number of times the at least one bidder failed to enter the auction does not exceed a preset value.

### BRIEF DESCRIPTION OF THE DRAWINGS

The disclosure will be better understood and when consideration is given to the drawings and the detailed description which follows. Such description makes reference to the annexed drawings wherein:

FIG. 1 is a view of a Japanese reverse auction in accordance with the prior art;

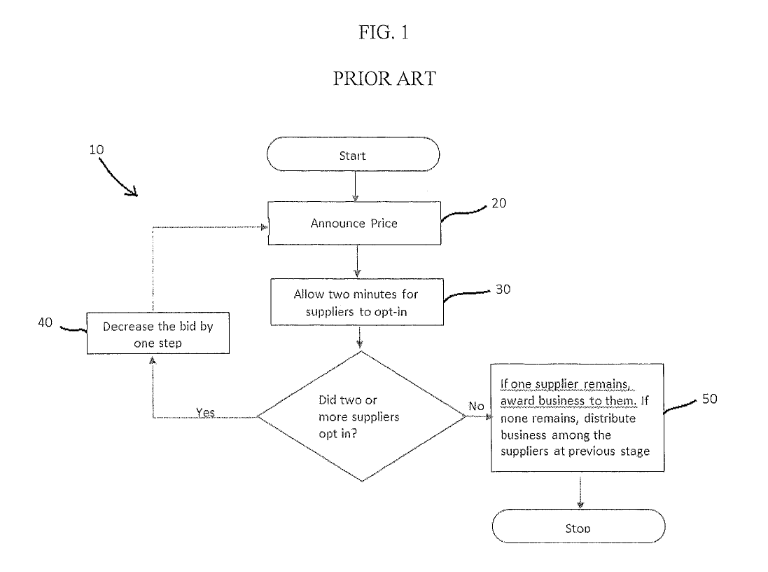

FIG. 2 is a view of a modified Japanese reverse auction in accordance with example embodiments;

FIG. 3 is a view of a system which may implement the modified Japanese reverse auction in accordance with example embodiments; and

FIG. 4 is a view of a server in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a modified Japanese reverse auction.

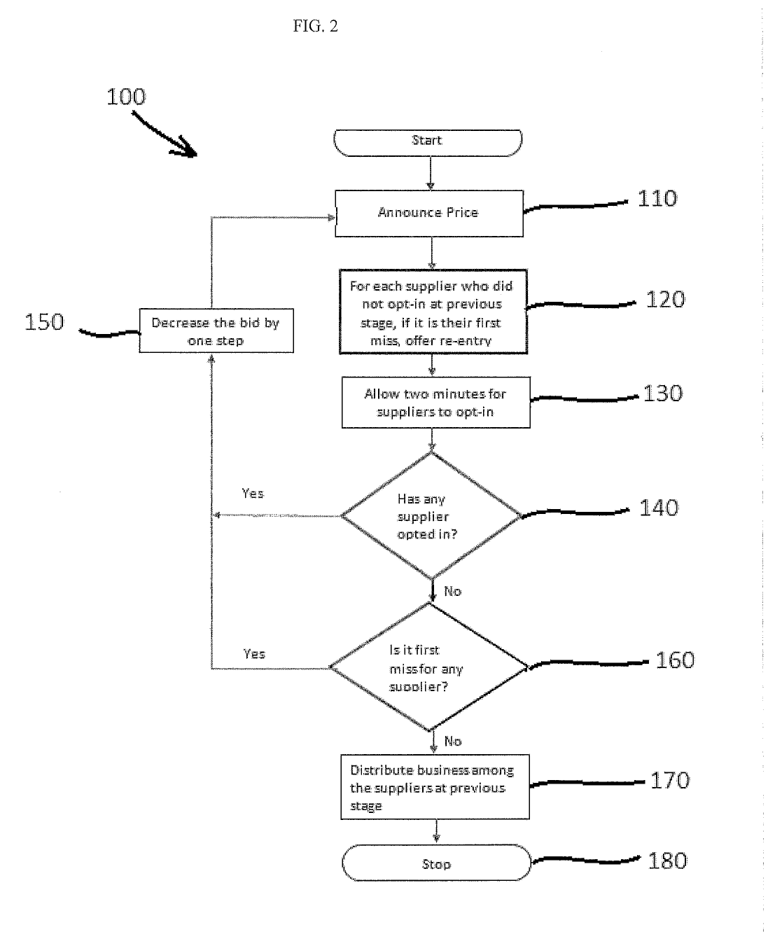

FIG. 2 is a flow chart of an example auction 100 in accordance with example embodiments. As shown in FIG. 2, the auction 100 may begin by announcing a price for an item 110. In example embodiments the item 110 may be any auctionable item, for example, clothing, electronic equipment, books, a service, etc. In example embodiments, once a price is set for an auction, the price is made available to suppliers and the suppliers are given two minutes to opt into the auction 130. Although the example of FIG. 2 provides a time limit of two minutes, this aspect of example embodiments is not intended to limit the invention as the time limit may be more than two minutes (for example, 3 minutes) or less than two minutes (for example, 1 minute).

In example embodiments, if one or more supplier has opted into the auction the price of the item may be reduced by a step 150. In example embodiments the step may be a predetermined step or a preset step. For example, in example embodiment the step may be a fixed step. For example, if the announced price was $500, the step may be $50. On the other hand, the step may be a proportion of the announced price, For example, if the announced price was $500 the step may be 10% of the announced price, for example, $50. In this latter embodiment, if the announced price was reduced to $450 due to operation of step 150, the next step may, instead of being $50, may be $45 (10% of $450). In other words, the amount of the particular step utilized in example embodiments is not intended to limit the invention.

In example embodiments, if no supplier has opted into the auction 100 the method queries whether or not this is a first miss for any supplier 160. If so, the announced price is decreased by the step and each supplier who did not opt in is offered a reentry and given time to bid 120. If any supplier reenters then the price is again decreased by one step and the new price is announced again. If no supplier opted in and if it was not a first miss for any supplier, then the business is distributed among the suppliers at the previous stage 170.

The following is example of the modified Japanese auction in accordance with example embodiments.
a) Auction starts at $500 for a widget and the price is announced (see step 110). Step is defined as $50.
b) Because the auction has started there is no offer for reentry for any bidders since no bidder has failed to previously opt in (see step 120).
c) Three suppliers (supplier 1, supplier 2, and supplier 3) opt in (see step 130). In this example a supplier is an example of a bidder.
d) Bid price is reduced to $450 via operation 150 and the new price ($450) is announced via operation 110.
e) Because no supplier has failed to opt in at a previous stage no supplier is provided an opportunity to reenter the auction.
f) Supplier 2 and supplier 3 place bids, supplier 1 does not place a bid.
g) Bid price is reduced to $400 via operation 150 and the new price ($400) is announced via operation 110.
h) Supplier 1 is offered a choice to reenter the auction via operation 120 since supplier 1 failed to offer a bid in the previous round. Supplier 1 decides to reenter the auction and supplier 2 and supplier 3 enter bids.
i) Bid price is reduced to $350 via operation 150 and the new price ($350) is announced via operation 110.
j) Supplier 1 bids on the widget, supplier 2 and supplier 3 do not place bids.
k) Bid price is reduced to $300 via operation 150 and the new bid price ($300) is announced via operation 110.
l) Supplier 2 and 3 are offered a chance to enter the auction via operation 120 but refuse, supplier 1, not knowing that supplier 2 and 3 have refused, bids again on the widget.
m) Bid price is reduced to $250 via operation 150 and the new price ($250) is announced via operation 110.
n) No suppliers bid on the widget offered at $250.
o) Because each of the suppliers missed an opportunity to bid at least once the auction terminates and business is awarded to supplier 1 at $300.

The results of the modified Japanese Auction are different than would have been obtained in the traditional reverse Japanese Auction. For example, in the traditional Japanese Auction, the process would have stopped at step j) and supplier 1 would have been awarded business at $350. However, in example embodiments, the business would have been awarded to supplier 1 at $300. Thus, under the modified Japanese reverse auction a buyer has a chance to obtain better pricing than would have been obtained by the traditional Japanese reverse auction.

The following is another example of the modified Japanese auction in accordance with example embodiments.
a) Auction starts at $500 for a widget, step is defined as $50, three suppliers (supplier 1, supplier 2, and supplier 3) opt in.
b) Bid price is reduced to $450 via operation 150.
c) Supplier 1 places a bid, supplier 2 and supplier 3 do not bid.
d) Bid price is reduced to $400 via operation 150.
e) Supplier 1 places another bid, suppliers 2 and 3 are offered a choice to reenter the auction via operation 120, suppliers 2 and 3 do not offer a bid.
f) Bid price is reduced to $350 via operation 150.
g) Supplier 1 does not bid on the widget.
h) Bid price is reduced to $300 via operation 150.
i) Supplier 1 is offered a choice to reenter the auction via operation 120, supplier 1 takes the offer and bids again.
j) Bid price is reduced to $250 via operation 150.
k) No suppliers bid on the widget offered at $250.
l) Supplier 1 wins and is awarded the bid at $300.

The results of the modified Japanese Auction are again different from what would have been obtained in the traditional reverse Japanese Auction. For example, in the traditional Japanese Auction, the process would have stopped at step c) and supplier 1 would have been awarded business at $450. However, in example embodiments, the business would have been awarded to supplier 1 at $300. Thus, under the modified Japanese reverse auction the buyer would have again obtained a better price for the widget.

The modified Japanese reverse auction in accordance with example embodiments solves several problems associated with the traditional Japanese reverse auction. First, there is an element of coercion for each supplier not present in the traditional Japanese reverse auction. For example, when a supplier opts out they may get a message stating that they have opted out and hence lost the business, but that they have one last opportunity to enter the fray again. Second, when there is a single supplier, the modified Japanese reverse auction pressures the single supplier to provide a more optimal pricing than the traditional Japanese reverse auction since the auction always decrements without the supplier knowing whether or not there are other bidders. Third, because suppliers have only one chance to enter the fray again after failing to place a bid, there is an urgency to ensure opt-in when each decrement is reduced. Further, in the event there is an technical issue, the supplier may lose their chance to bid on an item, however, under the modified Japanese reverse auction, the supplier may still remain in the fray while the technical issue is solved.

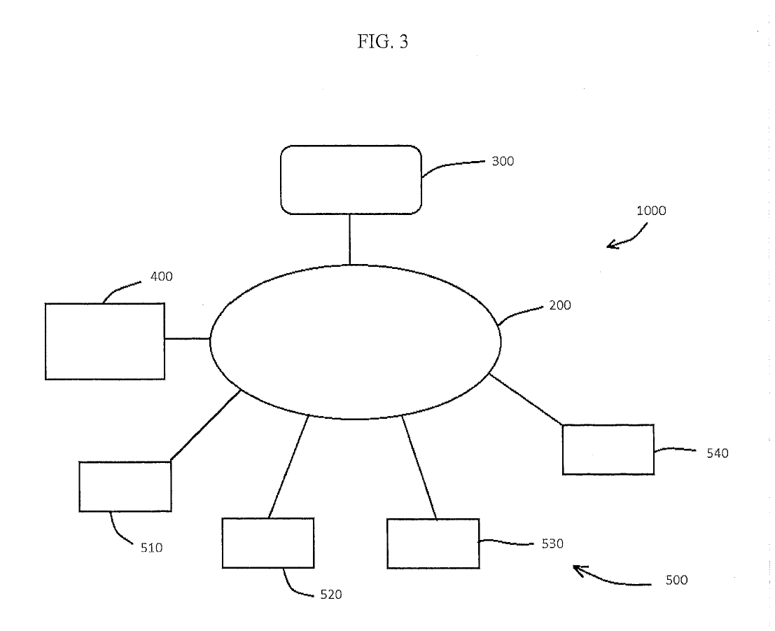

FIG. 3 is a block diagram of a system 1000 which may implement the modified Japanese reverse auction in accordance with example embodiments. The system 1000 is meant only for purposes of illustration only and is not intended to limit the scope of the invention since the modified Japanese reverse auction may be implemented in a variety of ways.

Referring to FIG. 3, the example system 1000 may include a network 200, a server 300, a buyer interface 400, and at least one supplier interface 500. For example, in example embodiments, the at least one supplier interface 500 may be only a single supplier interface or a plurality of supplier interfaces. In FIG. 3 four supplier interfaces 510, 520, 530, and 540, are illustrated, however, in example embodiments there may be more than four supplier interfaces or less than four supplier interfaces connected to the network 200. In example embodiments the network 200 provides electronic communication between the buyer interface 400, the supplier interfaces 500 and the server 300 and may be, but is not limited to, a communication network such as the internet, public network, exclusive line, and mobile communication network.

In example embodiments, the server 300 may acquire and control procurement information containing a desired product and procurement amount which may be transmitted by the buyer via the buyer interface 400. In example embodiments the buyer interface 400 may, for example, be a personal computer (for example, one that includes CPU, ROM, RAM, hard disk, display, keyboard, mouse, etc.). However, the buyer interface may be another device configured to access the server 300, for example, a portal or a portable hand held device such as, but not limited to, a smart phone. In example embodiments the buyer may provide information to the server 300 such as, but not limited to, the name of the reverse target item, a total procurement amount, a reverse auction starting price, step amount information and, if the item is to be procured is a service, the scale of the service such as, but not limited to, number of hours of personal service, the number of words in a translation service, the area of a floor to be cleaned, etc.

In example embodiments the server 300 may execute a program which drives the modified Japanese reverse auction method. For example, the server 300 may have a computer readable medium therein encoded with instructions that cause a computer to execute the steps associated with FIG. 2. During the auction, the suppliers may enter information via the supplier interfaces 510, 520, 530, and 540 and the server 300 may use this information during the auction. Like the buyer interface 400, the supplier interfaces 500 may be computers or any other electronic device configured to communicate over the network 200, such as but not limited to, smart phones.

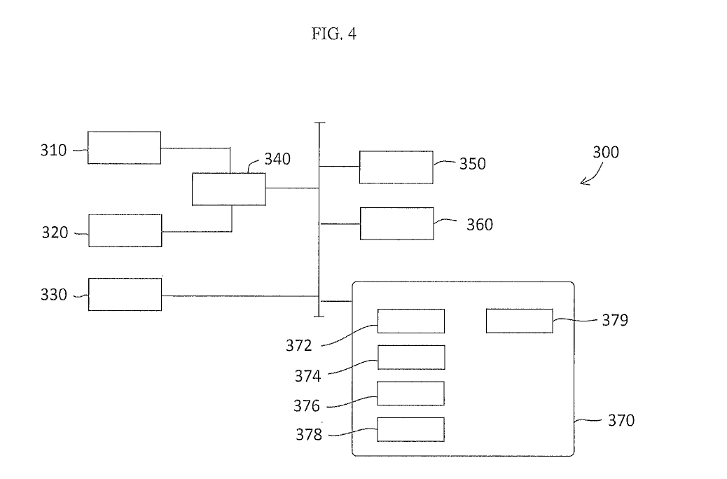

FIG. 4 shows the hardware components of the server 300 in accordance with example embodiments. It is understood that the server 300 may be configured in various ways, as such, the particular server 300 illustrated in FIG. 4 and described herein is not intended to limit the invention. Referring to FIG. 4, the example server 300 may include an input device 310, for example, a computer or a mouse, an output device 320, such as a monitor or printer, an input/output interface 340 for controlling their input and output, and a communication interface 330 for transmitting and receiving data through the network 200 which may be, but is not required to be, a LAN, telephone network, or package exchange network. In example embodiments, the server 300 may further include a CPU 350 for processing commands, an internal memory 360, and an external memory 370. The external memory 370 may be a hard disk device, for example, which may be placed in the same computer together with other components or may be a physically separated database or a combination of a plurality of hard disks or databases.

In example embodiments the CPU 350 is a central processing unit that may execute processing steps on the server 300 in accordance with a control program which may be stored in an internal memory 360 or the external storage device 370. In example embodiments the external storage device 370 may store the modified Japanese reverse auction execution program 372 and may also store buyer information in a buyer information table 374 and supplier information in a supplier information table 376. In example embodiments, the modified Japanese reverse auction execution program 372 may cause the processor 350 to execute the steps associated with the flowchart of FIG. 2.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the claims.

What is claimed is:

1. A method of conducting an auction comprising:
determining whether at least one bidder in the auction failed to opt into the auction at an earlier stage and, if so, offer the at least one bidder an opportunity to reenter the auction provided the total number of times the at least one bidder failed to enter the auction does not exceed a preset value.

2. The method of claim 1, wherein the preset value is 1.

3. The method of claim 1, further comprising:
setting an initial price of an item.

4. The method of claim 3, further comprising:
decreasing the initial price of the item by a step and reoffering the item at the decreased price.

5. The method of claim 4, where the initial price is decreased provided the at least one bidder bids on the initial price.

6. The method of claim 1, wherein if all bidders in the auction fail to place a bid and the
at least one of the bidders did not previously fail to offer a bid then decrease a price and reoffer the decreased price to the at least one bidder.

7. A control method by a server connected to a plurality of supplier terminals through a network, comprising:
using a CPU to determine whether at least one bidder in the auction failed to opt into the auction at an earlier stage and, if so, offer the at least one bidder an opportunity to reenter the auction provided the total number of times the at least one bidder failed to enter the auction does not exceed a preset value.

8. The control method of claim 7, wherein the preset value is 1.

9. The control method of claim 7, further comprising:
storing an initial price of an item in a database and making the initial price of the item available to the plurality of suppliers.

10. The method of claim 9, further comprising:
using the CPU to decrease the initial price of the item by a step and reoffering the item at the decreased price.

11. The control control method of claim 10, where the initial price is decreased provided the at least one bidder bids on the initial price.

12. The control method of claim 7, wherein the CPU is further configured to decrease a price if all bidders in the auction fail to place a bid and at least one of the bidders did not previously fail to offer a bid.

13. The control method of claim 12, wherein the CPU is further configured to reoffer the decreased price to the bidders who did not previously fail to offer a bid.

14. A system comprising:
a server having a computer readable medium encoded with instructions to cause a processor to determine whether at least one bidder in the auction failed to opt into the auction at an earlier stage and, if so, offer the at least one bidder an opportunity to reenter the auction provided the total number of times the at least one bidder failed to enter the auction does not exceed a preset value.

15. The system of claim 14, wherein the preset value is 1.

16. The system of claim 14, wherein the server is configured to retrieve initial price information set by a buyer.

17. The system of claim 16, wherein the instructions further cause the processor to decrease the initial price of the item by a step and reoffer the item at the decreased price.

18. The system of claim 17, where the initial price is decreased provided the at least one bidder bids on the initial price.

19. The system of claim 14, wherein the instructions further cause the processor to decrease the price again and reoffer the decreased price to at least one bidder which did not previously fail to offer the bid in the event all bidders in the auction failed to place a bid.
